(19) United States
(12) Patent Application Publication
(10) Pub. No.: US 2026/0147131 A1
(43) Pub. Date: May 28, 2026

(54) MICROSEISMIC INTERFERENCE POSITIONING METHOD AND SYSTEM BASED ON TIME-SHIFT CORRELATION COEFFICIENT, ELECTRONIC DEVICE, AND STORAGE MEDIUM

(71) Applicant: Southwest Petroleum University, Chengdu (CN)

(72) Inventors: Yuwei Wang, Chengdu (CN); Zixiu Wang, Chengdu (CN); Cheng Yin, Chengdu (CN); Yang Lin, Chengdu (CN); Hu Zhao, Chengdu (CN); Shulin Pan, Chengdu (CN); Wei Liu, Chengdu (CN); Zhiguo Fu, Chengdu (CN)

(21) Appl. No.: 19/373,757

(22) Filed: Oct. 30, 2025

(30) Foreign Application Priority Data
Nov. 27, 2024 (CN) 202411713509.0

(51) Int. Cl. G01V 1/28; G01V 1/30

(52) U.S. Cl. CPC G01V 1/288; G01V 1/303; G01V 2210/74

(57) ABSTRACT

A microseismic interference positioning method and system based on a time-shift correlation coefficient, an electronic device and a storage medium are provided. The method includes: constructing a DTW time-shift correlation coefficient by using a DTW algorithm; multiplying the constructed time-shift correlation coefficient by an imaging operator; stacking all time-shift correlated gathers at a same grid point to obtain an imaging result for a single grid point; and stacking imaging results of all grid points to obtain a final imaging map characterizing a location of a microseismic source. A position with a maximum imaging value is the location of the microseismic source, thereby positioning the microseismic source. The method can solve a problem of reduced imaging resolution of cross-correlation imaging operators caused by wave propagation effects and noise, and improves the positioning performance under the influence of noise contamination.

### CROSS-REFERENCE TO RELATED APPLICATION

This application claims priority to Chinese Patent Application No. 202411713509.0, filed on Nov. 27, 2024, which is herein incorporated by reference in its entirety.

### TECHNICAL FIELD

The disclosure relates to the field of microseismic detection technologies, and more particularly to a microseismic interference positioning method and system based on a time-shift correlation coefficient, an electronic device, and a storage medium.

### BACKGROUND

During oil and gas extraction, hydraulic fracturing technology is commonly used to enhance well productivity. Fracturing operations cause underground rocks to fracture, thereby radiating energy outward and leading to rock dislocations. These dislocations are similar to natural earthquakes along fault planes but are smaller in magnitude, hence termed “microseismic events”. The occurrence of a large number of microseismic events can provide sufficient microseismic data for processing and interpretation.

Microseismic monitoring technology utilizes microseismic events induced by the failure of underground rock layers for reservoir monitoring and subsurface fracture characterization. Unlike conventional seismic exploration, in microseismic monitoring, the location, strength, and origin time of the microseismic source are all unknown. Therefore, source positioning is a foundation of microseismic monitoring. Traditional microseismic positioning methods use picked arrival times and a given velocity model to perform linear travel time inversion based on ray theory to determine the location of the microseismic source. However, since microseismic events have low magnitude and low signal-to-noise ratio (SNR), it is difficult to perform accurate arrival time picking and microseismic source positioning. Compared to traditional travel time inversion methods, waveform-based positioning methods do not require phase picking and can detect and position more events using low-SNR data.

The waveform-based positioning methods can be broadly divided into reverse-time migration (RTM) imaging methods and waveform stacking methods that primarily utilize the first-arriving microseismic phase. RTM requires wavefield extrapolation, which is computationally intensive, and the imaging condition used significantly impacts positioning results of the microseismic source. The waveform stacking methods initially primarily use a diffraction stacking operator to focus or back-project energy along a travel time curve onto spatial grid points. In recent years, such methods have been successfully used to position natural earthquakes and induced seismicity related to mining operations, geothermal extraction, and oil and gas reservoirs. However, the diffraction stacking method requires searching for the origin time of the source during imaging, and errors in the origin time also affect the final positioning accuracy.

A cross-correlation stacking source positioning method belongs to a category of interferometric imaging methods, which is a relatively new waveform stacking positioning method. This method uses travel time difference information extracted by a cross-correlation operator for stacking imaging, which can avoid the search for the origin time. Furthermore, weighting the different travel time difference information according to the characteristics of different microseismic phases can improve positioning accuracy. Under influence of factors such as the source mechanism, medium variations, and ambient noise, microseismic waveforms exhibit different time-shifts at different times across receivers. A global time-shift amount calculated by using cross-correlation cannot achieve good alignment of varying waveforms of the microseismic events, thereby impacting the positioning accuracy. Most current methods use characteristic functions to transform the original waveforms. The characteristic functions can effectively avoid influence of variations in the first-arrival waveform and reduce sensitivity to velocity errors, but they sacrifice a spatial resolution of the imaging and are susceptible to noise. Therefore, it is necessary to find a method that can achieve accurate alignment between varying waveforms and use it for accurate microseismic positioning.

### SUMMARY

An objective of the disclosure is to provide a microseismic interference positioning method and system based on a time-shift correlation coefficient, an electronic device and a storage medium to solve the above problems in the related art.

In order to achieve the above objective, the disclosure provides a microseismic interference positioning method based on a time-shift correlation coefficient, including:
obtaining a velocity model and microseismic records of a monitoring area;
dividing, based on a preset grid size, the velocity model into multiple grid points, and performing a travel time calculation on each of the multiple grid points to obtain a travel-time table containing theoretical travel time data;
performing a dynamic time warping (DTW) calculation on each pair of traces in the microseismic records to obtain a time-shift amount of a sampling point corresponding to each pair of the traces, picking a first arrival time of a microseismic event, constructing, based on a time-shift of the first arrival time, a time-shift sequence of each sampling point relative to the first arrival time, and calculating, based on the time-shift sequence, a time-shift correlation coefficient for each pair of the traces to obtain time-shift correlated gathers containing information on actual observed travel time differences;
obtaining, based on the time-shift correlated gathers and the travel-time table, an imaging result corresponding to each of the multiple grid points; and
constructing, based on the imaging result corresponding to each of the multiple grid points, a final imaging map characterizing a location of a microseismic source, and determining, based on the final imaging map, the location of the microseismic source.

In an exemplary embodiment, a computer-implemented method for microseismic interference positioning and reservoir stimulation evaluation is provided, including:
obtaining, by one or more sensors deployed in a subsurface formation, microseismic records generated during hydraulic fracturing operations, and obtaining a velocity model of the subsurface formation;
dividing, based on a preset grid size, the velocity model into multiple grid points, and performing a travel time calculation on each of the multiple grid points to obtain a travel-time table containing theoretical travel time data;
performing a dynamic time warping (DTW) calculation on each pair of traces in the microseismic records to obtain a time-shift amount of a sampling point corresponding to each pair of the traces, picking a first arrival time of a microseismic event, constructing, based on a time-shift of the first arrival time, a time-shift sequence of each sampling point relative to the first arrival time, and calculating, based on the time-shift sequence, a time-shift correlation coefficient for each pair of the traces to obtain time-shift correlated gathers containing information on actual observed travel time differences;
obtaining, based on the time-shift correlated gathers and the travel-time table, an imaging result corresponding to each of the multiple grid points;
constructing, based on the imaging result corresponding to each of the multiple grid points, a final imaging map characterizing a location of a microseismic source, and determining, based on the final imaging map, the location of the microseismic source;
determining, based on the final imaging map, spatiotemporal evolution patterns of the microseismic sources over a predetermined time period, evaluating, by using the spatiotemporal evolution patterns, an efficiency of the hydraulic fracturing operation in enhancing fracture network development within the subsurface formation, and generating, by a computing system, a control signal or recommendation for adjusting injection parameters in real-time based on the evaluation.

In an embodiment, the performing a travel time calculation on each of the multiple grid points to obtain a travel-time table containing theoretical travel time data specifically includes:
calculating the theoretical travel time data from each of the multiple grid points to each receiver, and constructing, based on the theoretical travel time data, the travel-time table.

In an embodiment, a specific calculation formula of the constructing, based on a time-shift of the first arrival time, a time-shift sequence of each sampling point relative to the first arrival time is as follows:

$${τ}_{T C} ( {t}_{i} ) = {τ}_{t} ( {t}_{i} ) - {τ}_{t} ( {t}_{fb} ) , {t}_{i} = [ {τ}_{f irst} , {τ}_{max} ]$$

where i represents a sampling point corresponding to the time-shift sequence, tᵢ represents a time corresponding to the sampling point, t_{first} to tₘₐₓ represents a range of the time corresponding to the sampling point, τₜ(tᵢ) represents a time-shift amount corresponding to the time of the sampling point obtained by calculation, τₜ(t_{fb}) represents a time-shift amount corresponding to a first arrival time t_{fb} of a microseismic signal, and τ_{TC} represents a relative time-shift amount of the time tᵢ corresponding to the sampling point.

In an embodiment, a specific calculation formula of the calculating, based on the time-shift sequence, a time-shift correlation coefficient for each pair of the traces to obtain time-shift correlated gathers containing information on actual observed travel time differences is as follows:

$${C}_{TC} ( τ , i , j ) = {{\sum }^{{t}_{max} \sum }}_{{t}_{i} = {t}_{first}} u ( {t}_{i} , i ) u ( {t}_{i} + τ + {τ}_{T C} ( {t}_{i} ) , j )$$

where i and j each represent a receiver number, τ represents the time-shift amount of the sampling point corresponding to each pair of the traces, τ_{TC} represents a relative time-shift amount, u(tᵢ, i) represents a time sequence corresponding to a receiver i, u(tᵢ+τ+τ_{TC}(tᵢ),j) represents a relative time-shift sequence of a receiver j relative to the receiver i, ta represents a time corresponding to the sampling point, t_{first} to tₘₐₓ represents a range of the time corresponding to the sampling point, and C_{TC} represents the time-shift correlation coefficient for each pair of the traces based on DTW.

In an embodiment, the obtaining, based on the time-shift correlated gathers and the travel-time table, an imaging result corresponding to each of the multiple grid points specifically includes:
multiplying the time-shift correlated gathers with an interferometric imaging operator containing the theoretical travel time data to perform interferometric imaging, and stacking all of the time-shift correlated gathers at a same grid point of the multiple grid points to obtain the imaging result corresponding to each of the multiple grid points.

In an embodiment, the determining, based on the final imaging map, the location of the microseismic source specifically includes:
determining a location corresponding to a maximum imaging value in the final imaging map to obtain the location of the microseismic source, to thereby position the microseismic source.

A microseismic interference positioning system based on a time-shift correlation coefficient includes a data acquisition module, a travel-time table calculation module, a time-shift correlation coefficient calculation module, and a positioning module.

The data acquisition module is configured to obtain a velocity model and microseismic records of a monitoring area.

The travel-time table calculation module is configured to divide the velocity model into multiple grid points based on a preset grid size, and perform a travel time calculation on each of the multiple grid points to obtain a travel-time table containing theoretical travel time data.

The time-shift correlation coefficient calculation module is configured to perform a DTW calculation on each pair of traces in the microseismic records to obtain a time-shift amount of a sampling point corresponding to each pair of the traces, pick a first arrival time of a microseismic event, construct a time-shift sequence of each sampling point relative to the first arrival time based on a time-shift of the first arrival time, and calculate a time-shift correlation coefficient for each pair of the traces based on the time-shift sequence to obtain time-shift correlated gathers containing information on actual observed travel time differences.

The positioning module is configured to obtain an imaging result corresponding to each of the multiple grid points based on the time-shift correlated gathers and the travel-time table, construct a final imaging map characterizing a location of a microseismic source based on the imaging result corresponding to each of the multiple grid points, and determine the location of the microseismic source based on the final imaging map.

In an embodiment, each of the data acquisition module, the travel-time table calculation module, the time-shift correlation coefficient calculation module, and the positioning module is embodied by at least one processor and at least one memory coupled to the at least one processor, and the at least one memory stores computer programs executable by the at least one processor.

An electronic device includes a memory and a processor. The memory is configured to store a computer program, and the processor is configured to execute the computer program to cause the electronic device to perform the microseismic interference positioning method based on the time-shift correlation coefficient.

A non-transitory computer-readable storage medium has a computer program stored therein. The computer program is configured to be executed by a processor to implement the microseismic interference positioning method based on the time-shift correlation coefficient. Technical effects of the disclosure are as follows.

The disclosure utilizes the DTW algorithm to construct a DTW time-shift correlation coefficient. The DTW time-shift correlation coefficient is multiplied with an imaging operator (i.e., interferometric imaging operator), and all time-shift correlated gathers are stacked at the same grid point to obtain an imaging result for a single grid point. By further stacking all imaging results of each grid point, the final imaging map characterizing the location of the microseismic source is obtained, and the location with the maximum imaging value corresponds to the microseismic source, thereby positioning the microseismic source. By using the DTW method to construct the time-shift correlation coefficient and using the time-shift correlation coefficient in multiplication with the imaging operator followed by stacking to image the location of the microseismic source, the disclosure yields a more focused and superior imaging result compared to those obtained from traditional cross-correlation-based interferometric imaging methods. The disclosure effectively addresses the issue of reduced imaging resolution in cross-correlation imaging operators caused by wave propagation effects and noise, thereby enhancing the positioning performance under the influence of noise contamination.

### BRIEF DESCRIPTION OF DRAWINGS

In order to more clearly illustrate embodiments of the disclosure or technical solutions in the related art, drawings required for use in the embodiments will be briefly introduced below. Apparently, the drawings described below are merely some of the embodiments of the disclosure. For those skilled in the art, other drawings can be obtained based on these drawings without paying creative work.

The drawings constituting a part of the disclosure are used to provide a further understanding of the disclosure. The illustrative embodiments and descriptions of the disclosure are used to explain the disclosure and do not constitute an improper limitation on the disclosure.

FIG. 1 illustrates a flowchart of implementing a microseismic interference positioning method based on a time-shift correlation coefficient according to an embodiment of the disclosure.

FIG. 2 illustrates a schematic diagram of a time-shift correlation coefficient proposed in the embodiment of the disclosure and a traditional cross-correlation coefficient.

FIG. 3 illustrates a schematic diagram of a velocity model used in forward modeling according to an embodiment of the disclosure.

FIG. 4 illustrates a schematic diagram of noisy microseismic data generated by adding-12 decibels (dB) Gaussian noise to original microseismic data according to an embodiment of the disclosure.

FIG. 5 illustrates a schematic diagram of filtered microseismic data obtained by 5-80 hertz (Hz) bandpass filtering of data containing-12 dB Gaussian noise according to an embodiment of the disclosure.

FIG. 6 illustrates a schematic diagram of positioning results obtained by using filtered data and using traditional cross-correlation interference positioning and the microseismic interference positioning method based on the time-shift correlation coefficient proposed in the disclosure.

### DETAILED DESCRIPTION OF EMBODIMENTS

A detailed description will be made for exemplary embodiments of the disclosure with reference to drawings. This detailed description should not be considered as a limitation to the disclosure, but rather as a more detailed description of certain aspects, features, and embodiments of the disclosure.

It should be understood that terms used in the disclosure are only for describing specific embodiments and are not intended to limit the disclosure. Furthermore, for numerical ranges in the disclosure, it should be understood that each intermediate value between upper and lower limits of the range is also specifically disclosed. Any stated value or intermediate value within the stated range, and every smaller range between any other stated value or intermediate value within the said range, is also included in the disclosure. The upper and lower limits of these smaller ranges can be independently included or excluded from the range.

Various modifications and changes can be made to the specific embodiments described in the specification of the disclosure without departing from a scope or a spirit of the disclosure, which will be obvious to those skilled in the art. Other embodiments obtained from the description of the disclosure will be obvious to those skilled in the art. The description and examples of the disclosure are illustrative only.

As used herein, “comprising”, “including”, “having”, “containing” and the like are open-ended terms, meaning including but not limited to.

It should be noted that, in the case of no conflict, the embodiments in the disclosure and the features in the embodiments can be combined with each other. The disclosure will be described in detail below with reference to the embodiments and the drawings.

### Embodiment 1

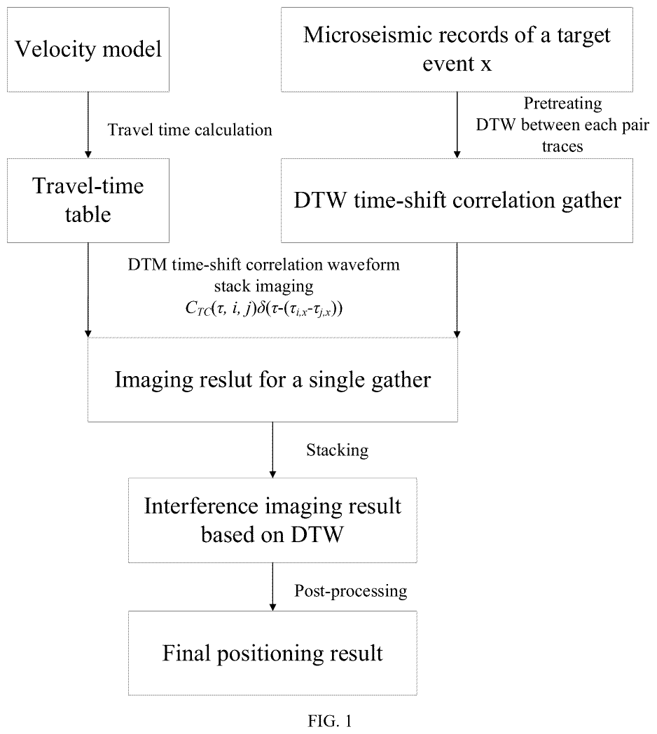

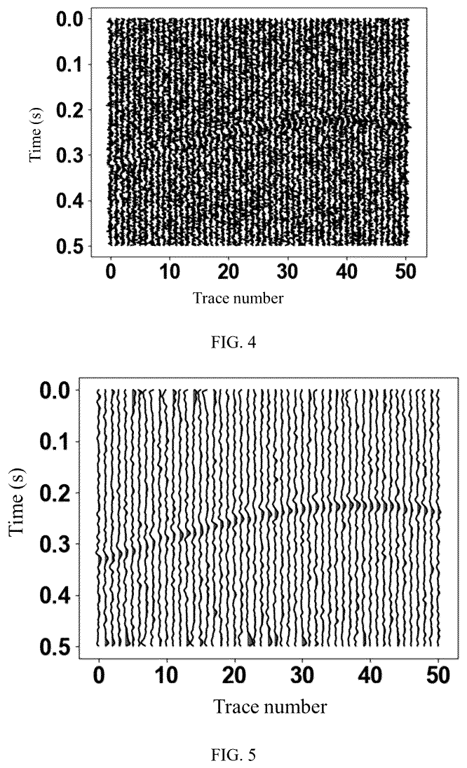

As shown in FIGS. 1 to 6, the embodiment provides a microseismic interference positioning method based on a time-shift correlation coefficient, and the method includes the following steps. A velocity model and microseismic records of a monitoring area are obtained. The velocity model is divided into multiple grid points based on a preset grid size. A travel time calculation is performed on each grid point to obtain a travel-time table containing theoretical travel time data. A DTW calculation is performed on each pair of traces in the microseismic records to obtain a time-shift amount of a sample point corresponding to each pair of the traces. A first arrival time of a microseismic event is picked. A time-shift sequence of each sampling point relative to the first arrival time is constructed based on a time-shift of the first arrival time. A time-shift correlation coefficient for each pair of the traces is calculated based on the time-shift sequence to obtain time-shift correlated gathers containing information on actual observed travel time differences. An imaging result corresponding to each grid point is obtained based on the time-shift correlated gathers and the travel-time table. A final imaging map characterizing a location of a microseismic source is constructed based on the imaging result corresponding to each grid point. The location of the microseismic source is determined based on the final imaging map.

The embodiment utilizes the DTW algorithm to construct a DTW time-shift correlation coefficient. The DTW time-shift correlation coefficient is multiplied with an imaging operator, and all of the time-shift correlated gathers are stacked at the same grid point to obtain an imaging result for a single grid point. By further stacking all imaging results of each grid point, the final imaging map characterizing the location of the microseismic source is obtained, and the location with the maximum imaging value corresponds to the microseismic source, thereby positioning the microseismic source. By using the DTW method to construct the time-shift correlation coefficient and using the time-shift correlation coefficient in multiplication with the imaging operator followed by stacking to image the location of the microseismic source, the disclosure yields a more focused and superior imaging result compared to those obtained from traditional cross-correlation-based interferometric imaging methods. The disclosure effectively addresses the issue of reduced imaging resolution in cross-correlation imaging operators caused by wave propagation effects and noise, thereby enhancing the positioning performance under the influence of noise contamination. The specific technical scheme adopted in the embodiment is as follows.

In step 1, a travel-time table is calculated. The velocity model of the monitoring area is divided into multiple grid points according to a certain grid size. Each grid point is treated as a potential source. A theoretical travel time from each grid point to each receiver is calculated to obtain a corresponding travel-time table. Optionally, in order to calculate travel times efficiently, the embodiment uses an open-source Python™ package Fteikpy for rapid solution of an Eikonal equation. Compared with the related art, the use of Fteikpy significantly reduces computational complexity while ensuring calculation accuracy.

In step 2, a time-shift correlation coefficient is calculated. A DTW calculation is performed on each pair of traces in the microseismic records. The result of the DTW algorithm is the time-shift amount for a sample point corresponding to each pair of the traces, thereby obtaining a time-shift τₜ for each sampling point of the waveform corresponding to the microseismic event. A first arrival time t_{first} of the corresponding microseismic event is picked. A time-shift τ_{fb} corresponding to the picked first arrival time is used as a benchmark, a relative time-shift sequence of the waveform relative to τ_{fb} is constructed. Optionally, in order to pick the first arrival time of the microseismic event, the embodiment uses the EventPicker Python package. Through the EventPicker package, the first arrival time t_{fb} can be accurately picked. Based on the obtained first arrival time, and the time-shift corresponding to the first arrival time is used as the benchmark, the relative time-shift sequence relative to the first arrival time is constructed as follows:

$${τ}_{T C} ( {t}_{i} ) = {τ}_{t} ( {t}_{i} ) - {τ}_{t} ( {t}_{fb} ) , {t}_{i} = [ {τ}_{f irst} , {τ}_{max} ]$$

where i represents a sampling point corresponding to the time-shift sequence, tᵢ represents a time corresponding to the sampling point, t_{first} to tₘₐₓ represents a range of the time corresponding to the sampling point, τₜ(tᵢ) represents a time-shift amount corresponding to the time of the sampling point obtained by calculation, τₜ(t_{fb}) represents a time-shift amount corresponding to a first arrival time t_{fb} of a microseismic signal, and τ_{TC} represents a relative time-shift amount of the time tᵢ of the sampling point.

A time-shift correlation coefficient between a relatively shifted microseismic trace with another trace is calculated to obtain time-shift correlated gathers containing information on actual observed travel time differences as follows:

$${C}_{TC} ( τ , i , j ) = {{\sum }^{{t}_{max} \sum }}_{{t}_{i} = {t}_{first}} u ( {t}_{i} , i ) u ( {t}_{i} + τ + {τ}_{T C} ( {t}_{i} ) , j )$$

where i and j each represent a receiver number, τ represents the time-shift amount of the sampling point corresponding to each pair of the traces, τ_{TC} represents a relative time-shift amount, u(tᵢ, i) represents a time sequence corresponding to a receiver i, u(tᵢ+τ+τ_{TC}(tᵢ), j) represents a relative time-shift sequence of a receiver j relative to the receiver i, tᵢ represents a time corresponding to a sampling point, t_{first} to tₘₐₓ represents a range of the time corresponding to the sampling point, and C_{TC} represents the time-shift correlation coefficient for each pair of the traces based on DTW.

In step 3, an imaging result for a single gather (i.e., the time-shift correlated gather) is obtained. The time-shift correlated gather is multiplied by an interferometric imaging operator containing the theoretical travel time difference information to perform interferometric imaging. All time-shift correlated gathers are stacked at the same grid point to obtain the imaging result for a single grid point as follows:

$${S}_{TC} ( x , i ) = {\sum }_{i \neq j}^{N} {\sum }_{τ = - {t}_{max}}^{{t}_{max}} {C}_{T C} ( τ , i , j ) δ ( τ - ( {τ}_{i , x} - {τ}_{j , x} ) )$$

where x represents a location vector of the microseismic source, δ represents a Dirac delta function, τ represents a time, N represents a number of receivers, τ_{i,x} and τ_{j,x} represent theoretical travel times from the microseismic source x to receivers i and j, respectively, S_{TC}(x, i) represents the imaging result for a single grid point. The interferometric imaging operator utilizes the travel time difference between the microseismic source and the receiver pair {i, j}.

In step 4, all imaging results of grid points are stacked to obtain a final imaging map characterizing a location of the microseismic source. A location with a maximum imaging value is the location of the microseismic source, thereby positioning the microseismic source. A formula of the final imaging map is expressed as follows:

$${S}_{TC} ( x ) = {\sum }_{i = 1}^{N} {S}_{T C} ( x , i )$$

where N represents the number of the receivers, and S_{TC}(x) represents the final imaging map.

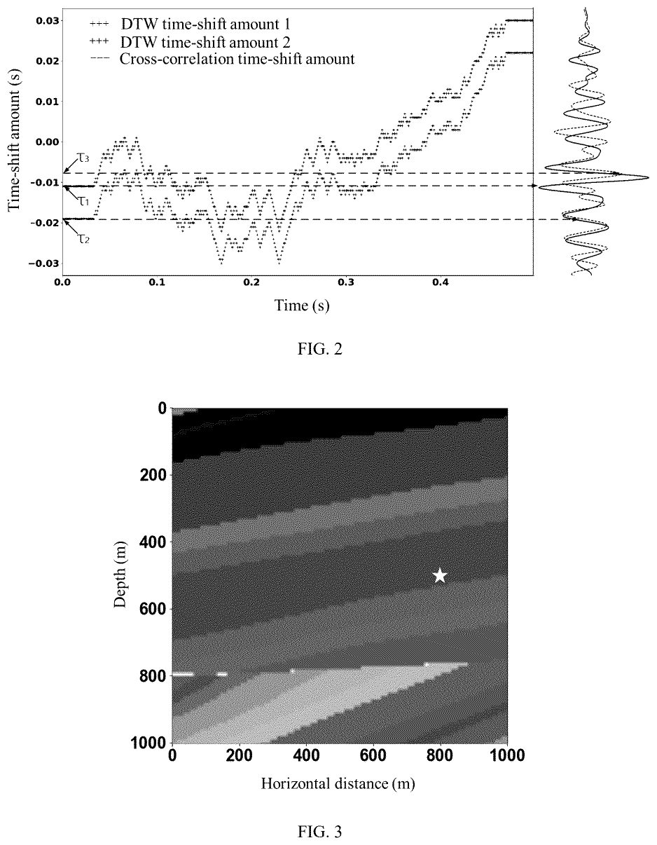

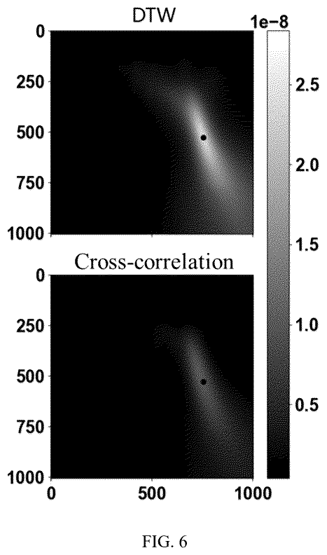

Compared with the traditional interferometric imaging method based on the cross-correlation coefficient, the embodiment constructs the time-shift correlation coefficient. A comparison between the time-shift correlation coefficient and the cross-correlation coefficient is shown in FIG. 2. FIG. 6 shows a comparison of the positioning results obtained by using the traditional cross-correlation interferometric positioning method and the microseismic interferometric positioning method based on the time-shift correlation coefficient proposed in the disclosure applied to the filtered data. The imaging effect based on the time-shift correlation coefficient is significantly improved.

The microseismic source locations determined by the disclosed method are not merely academic indicators but serve as critical inputs for real-world engineering decisions.

In oil and gas reservoir stimulation, the spatiotemporal distribution of located microseismic events is analyzed to evaluate whether the created fracture network has adequately covered the target zone. If the propagation direction or extent of microseismicity deviates from the design plan, the system automatically generates alerts or recommendations to adjust fluid injection rate, pressure, or proppant concentration in real time.

In enhanced geothermal systems (EGS), the clustering and migration of microseismic events indicate the formation of fluid pathways. By tracking these patterns, operators can identify effective permeability enhancement zones and optimize reinjection well placement.

In underground mining or tunneling operations, accelerating microseismic activity with increasing magnitude may signal rock mass instability. The high-resolution imaging enabled by the time-shift correlation coefficient allows earlier detection of precursory behavior, enabling proactive safety interventions such as evacuation or support reinforcement.

Thus, the improved accuracy and noise robustness of the proposed method directly translate into enhanced operational safety, resource recovery, and cost efficiency in subsurface engineering applications.

A microseismic interference positioning system based on a time-shift correlation coefficient includes a data acquisition module, a travel-time table calculation module, a time-shift correlation coefficient calculation module, and a positioning module.

The data acquisition module is configured to obtain a velocity model and microseismic records of a monitoring area.

The travel-time table calculation module is configured to divide the velocity model into multiple grid points based on a preset grid size, and perform a travel time calculation on each of the multiple grid points to obtain a travel-time table containing theoretical travel time data.

The time-shift correlation coefficient calculation module is configured to perform a DTW calculation on each pair of traces in the microseismic records to obtain a time-shift amount of a sampling point corresponding to each pair of the traces, pick a first arrival time of a microseismic event, construct a time-shift sequence of each sampling point relative to the first arrival time based on a time-shift of the first arrival time, and calculate a time-shift correlation coefficient for each pair of the traces based on the time-shift sequence to obtain time-shift correlated gathers containing information on actual observed travel time differences.

The positioning module is configured to obtain an imaging result corresponding to each of the multiple grid points based on the time-shift correlated gathers and the travel-time table, construct a final imaging map characterizing a location of a microseismic source based on the imaging result corresponding to each of the multiple grid points, and determine the location of the microseismic source based on the final imaging map.

An electronic device includes a memory and a processor. The memory is configured to store a computer program, and the processor is configured to execute the computer program to make the electronic device implement the microseismic interference positioning method based on the time-shift correlation coefficient.

A non-transitory computer-readable storage medium has a computer program stored therein. The computer program is configured to be executed by a processor to implement the microseismic interference positioning method based on the time-shift correlation coefficient.

The foregoing descriptions are merely specific implementation modes of the disclosure. However, a protection scope of the disclosure is not limited thereto. Any person skilled in the art can readily conceive of changes or substitutions within the technical scope disclosed in the disclosure, which shall fall within the protection scope of the disclosure. Therefore, the protection scope of the disclosure shall be subject to the protection scope of the claims.

What is claimed is:

1. A microseismic interference positioning method based on a time-shift correlation coefficient, comprising:
obtaining a velocity model and microseismic records of a monitoring area;
dividing, based on a preset grid size, the velocity model into a plurality of grid points, and performing a travel time calculation on each of the plurality of grid points to obtain a travel-time table containing theoretical travel time data;
performing a dynamic time warping (DTW) calculation on each pair of traces in the microseismic records to obtain a time-shift amount of a sampling point corresponding to each pair of the traces, picking a first arrival time of a microseismic event, constructing, based on a time-shift of the first arrival time, a time-shift sequence of each sampling point relative to the first arrival time, and calculating, based on the time-shift sequence, a time-shift correlation coefficient for each pair of the traces to obtain time-shift correlated gathers containing information on actual observed travel time differences; wherein a specific calculation formula of the calculating, based on the time-shift sequence, a time-shift correlation coefficient for each pair of the traces to obtain time-shift correlated gathers containing information on actual observed travel time differences is as follows:
$${C}_{TC} ( τ , i , j ) = {\sum }_{{t}_{i} = {t}_{first}}^{{t}_{max} \sum } u ( {t}_{i} , i ) u ( {t}_{i} + τ + {τ}_{TC} ( {t}_{i} ) , j )$$
wherein i and j each represent a receiver number, τ represents the time-shift amount of the sampling point corresponding to each pair of the traces, τ_{TC} represents a relative time-shift amount, u(tᵢ, i) represents a time sequence corresponding to a receiver i, u(tᵢ+τ+τ_{TC}(tᵢ), j) represents a relative time-shift sequence of a receiver j relative to the receiver i, tᵢ represents a time corresponding to the sampling point, t_{first} to tₘₐₓ represents a range of the time corresponding to the sampling point, and C_{TC} represents the time-shift correlation coefficient for each pair of the traces based on DTW;
obtaining, based on the time-shift correlated gathers and the travel-time table, an imaging result corresponding to each of the plurality of grid points; and
constructing, based on the imaging result corresponding to each of the plurality of grid points, a final imaging map characterizing a location of a microseismic source, and determining, based on the final imaging map, the location of the microseismic source.

2. The microseismic interference positioning method based on the time-shift correlation coefficient as claimed in claim 1, wherein the performing a travel time calculation on each of the plurality of grid points to obtain a travel-time table containing theoretical travel time data specifically comprises:
calculating the theoretical travel time data from each of the plurality of grid points to each receiver, and constructing, based on the theoretical travel time data, the travel-time table.

3. The microseismic interference positioning method based on the time-shift correlation coefficient as claimed in claim 1, wherein a specific calculation formula of the constructing, based on a time-shift of the first arrival time, a time-shift sequence of each sampling point relative to the first arrival time is as follows:
$${τ}_{TC} ( {t}_{i} ) = {τ}_{t} ( {t}_{i} ) - {τ}_{t} ( {t}_{fb} ) , {t}_{i} = [ {τ}_{first} , {τ}_{max} ]$$
wherein i represents a sampling point corresponding to the time-shift sequence, t; represents a time corresponding to the sampling point, t_{first} to tₘₐₓ represents a range of the time corresponding to the sampling point, τₜ(tᵢ) represents a time-shift amount corresponding to the time of the sampling point obtained by calculation, τₜ(t_{fb}) represents a time-shift amount corresponding to a first arrival time t_{fb} of a microseismic signal, and τ_{TC} represents a relative time-shift amount of the time tᵢ corresponding to the sampling point.

4. The microseismic interference positioning method based on the time-shift correlation coefficient as claimed in claim 1, wherein the obtaining, based on the time-shift correlated gathers and the travel-time table, an imaging result corresponding to each of the plurality of grid points specifically comprises:
multiplying the time-shift correlated gathers with an interferometric imaging operator containing the theoretical travel time data to perform interferometric imaging, and stacking all the time-shift correlated gathers at a same grid point of the plurality of grid points to obtain the imaging result corresponding to each of the plurality of grid points.

5. The microseismic interference positioning method based on the time-shift correlation coefficient as claimed in claim 1, wherein the determining, based on the final imaging map, the location of the microseismic source specifically comprises:
determining a location corresponding to a maximum imaging value in the final imaging map to obtain the location of the microseismic source, to thereby position the microseismic source.

6. A microseismic interference positioning system based on a time-shift correlation coefficient, comprising:
a data acquisition module, configured to obtain a velocity model and microseismic records of a monitoring area;
a travel-time table calculation module, configured to divide the velocity model into a plurality of grid points based on a preset grid size, and perform a travel time calculation on each of the plurality of grid points to obtain a travel-time table containing theoretical travel time data;
a time-shift correlation coefficient calculation module, configured to perform a DTW calculation on each pair of traces in the microseismic records to obtain a time-shift amount of a sampling point corresponding to each pair of the traces, pick a first arrival time of a microseismic event, construct a time-shift sequence of each sampling point relative to the first arrival time based on a time-shift of the first arrival time, and calculate a time-shift correlation coefficient for each pair of the traces based on the time-shift sequence to obtain time-shift correlated gathers containing information on actual observed travel time differences; wherein a specific calculation formula of the time-shift correlated gathers is as follows:
$${C}_{TC} ( τ , i , j ) = {\sum }_{{t}_{i} = {t}_{first}}^{{t}_{max} \sum } u ( {t}_{i} , i ) u ( {t}_{i} + τ + {τ}_{TC} ( {t}_{i} ) , j )$$
wherein i and j each represent a receiver number, τ represents the time-shift amount of the sampling point corresponding to each pair of the traces, τ_{TC} represents a relative time-shift amount, u(tᵢ, i) represents a time sequence corresponding to a receiver i, u(tᵢ+τ+τ_{TC}(tᵢ), j) represents a relative time-shift sequence of a receiver j relative to the receiver i, tᵢ represents a time corresponding to the sampling point, t_{first} to tₘₐₓ represents a range of the time corresponding to the sampling point, and C_{TC} represents the time-shift correlation coefficient for each pair of the traces based on DTW; and
a positioning module, configured to obtain an imaging result corresponding to each of the plurality of grid points based on the time-shift correlated gathers and the travel-time table, construct a final imaging map characterizing a location of a microseismic source based on the imaging result corresponding to each of the plurality of grid points, and determine the location of the microseismic source based on the final imaging map.

7. An electronic device, comprising a memory and a processor, wherein the memory is configured to store a computer program, and the processor is configured to execute the computer program to make the electronic device implement the microseismic interference positioning method based on the time-shift correlation coefficient as claimed in claim 1.

8. A computer-readable storage medium, having a computer program stored therein, wherein the computer program is configured to be executed by a processor to implement the microseismic interference positioning method based on the time-shift correlation coefficient as claimed in claim 1.
